(19) United States
(12) Patent Application Publication
(10) Pub. No.: US 2002/0063137 A1
(43) Pub. Date: May 30, 2002

(54) Feeder for surface mounting device

(75) Inventors: Ji Hyun Hwang, Kyungki-do (KR); Do Hyun Kim, Kyoungki-do (KR); Sang Yeon Hwang, Kyoungki-do (KR)

Correspondence Address: FLESHNER & KIM, LLP, P.O. Box 221200, Chantilly, VA, 20153-1200, US

(73) Assignee: MIRAE Corporation

(21) Appl. No.: 09/987,379

(22) Filed: Nov. 14, 2001

(30) Foreign Application Priority Data
Nov. 24, 2000 (KR) 2000-70451

(51) Int. Cl. G07F 11/66

(52) U.S. Cl. 221/25

(57) ABSTRACT

A feeder for a surface mounting device includes: a main frame; a parts feeding unit including a forward/backward rotation force generating unit for carrying a tape by forwardly/backwardly rotating a circular permanent magnetic unit by a mutual magnetic force with armature coils, a driving gear for receiving the forward/backward rotation force and simultaneously carrying the tape at a constant distance and a position sensing unit for sensing the position of the permanent magnetic unit; a vinyl separation unit being for carrying the vinyl removed from the tape by the forward rotating force or re-carrying the vinyl by the backward rotating force; and a vinyl recovery unit for recovering the vinyl by winding the same by the forward rotating force unit or discharging the vinyl.

### BACKGROUND OF THE INVENTION

1. Field of the Invention

The present invention relates to a feeder for a surface mounting device, and more particularly, to a feeder for a surface mounting device which carries surface mounting parts to a parts suction position of a nozzle from the surface mounting device for sucking surface mounting parts and mounting them on a printed circuit board.

2. Description of the Related Art

A surface mounting device includes an X-Y gantry, a module head, a PCB carrier, and a feeder. The module head is assembled to be moved to the X-Y gantry in the X-Y axis direction and sucks surface mounting parts (Hereinafter, referred to as “parts”) onto a printed circuit board carried by the PCB carrier and then mounts them on the printed circuit board. The parts to be mounted on the printed circuit board are carried by the feeder and are mounted on the printed circuit board. The feeder which mounts parts on the printed circuit board will now be described with reference to the accompanying drawings.

As illustrated in FIG. 1, the feeder includes a vinyl recovery unit 10, a vinyl separation unit 20 and a feeding unit 30. A recovery reel 11 is mounted at the vinyl recovery unit 10 and then winds vinyl (V: shown in FIG. 3) carried by the vinyl separation unit 20 to recover the same. A tape (TF: shown in FIG. 3) for bonding the vinyl (V) recovered to the vinyl recovery unit 10 is fed to the feeder 30 from a tape take-up unit 50 (shown in FIG. 2) installed at the rear end of the vinyl recovery unit 10. The tape TF fed to the feeder 30 is moved by the feeder at a predetermined pitch for each movement and is carried to a work position. Then, it is sucked by a nozzle (N: shown in FIG. 2), is moved to a printed circuit board (not shown) and is mounted thereon.

The feeder which carries the tape TF to carry parts to a sucking position of the nozzle N includes a vinyl recovery unit 10, a vinyl separation unit 20, a feeding unit 30 and a tape take-up unit 50. The construction of each element will now be described with reference to FIG. 2. As illustrated in FIG. 2, the vinyl recovery unit 10 includes a recovery reel 11, a recovery rotation motor 12, a recovery unit worm 13, a recovery unit worm gear 14 and a recovery unit gear 15. The vinyl separation unit 20 includes a separation rotation motor 21, a separation unit worm 22, a separation unit worm gear 23, a first separation unit gear 24, a second separation unit gear 25, and a third separation unit gear 26. The parts feeding unit 30 includes a feed rotation motor 31, a feed worm 32, a sector gear 33, a first arm 34, a second arm 35, and a driving wheel 36 with driving teeth 36a.

At the vinyl recovery unit 10, the recovery rotation motor 12 generating a rotating force for rotating the recovery reel 11 is fixedly installed. At the central axis of rotation of the recovery rotation motor 12, the recovery unit worm 13 is installed. The recovery unit worm 13 is interlockingly rotated by the rotation of the recovery rotation motor 12, and the recovery unit worm gear 14 is rotated by the rotation of the recovery unit worm 13. The recovery unit worm 13 and the recovery unit worm gear 14 change the direction of rotational force generated from the recovery rotation motor 12 and transfers the same to the recovery unit gear 15. The recovery unit gear 15 having received a rotating force winds the vinyl V shown in FIG. 3 to recover the same by rotating the recovery reel 11 in a predetermined direction.

The vinyl V wound on the recovery reel 11 of the vinyl recovery unit 10 is carried to the vinyl separation unit 20. With respect to the vinyl separation unit 20, the rotating force generated from the vinyl rotation motor 21 is transferred to the separation unit worm 22 assembled at the central axis of rotation. The rotation force transferred to the separation unit worm 22 is transferred to the separation unit worm gear 23 assembled at the separation unit worm 22. In this process, the rotational direction is changed to be transferred to the first separation unit gear 24. The first separation unit gear 24 is assembled with the second separation unit gear 25 and the third separation unit gear 26 sequentially, and the second separation unit gear 25 and the third separation unit gear 26 are rotated in the opposite direction with each other by the rotation of the first separation unit gear 24.

While the second separation unit gear 25 and the third separation unit gear 26 are rotated in the opposite direction of the first separation unit gear 24, as shown in FIG. 3, the vinyl V attached to the tape TF inserted between the first separation unit gear 24 and the second separation unit gear 25 is carried to the vinyl recovery unit 10. Here, the tape TF is moved to the bottom of a cover 41 as shown in FIG. 3 by the rotation of the tape take-up unit 50 in a state where it is taken up around the tape take-up unit 50. The tape TF moved to the cover 41 is carried to an suction position A in a state where the vinyl V attached to the tape TF is removed. The tape TF has a plurality of parts mounting grooves L formed at a constant interval, and parts are mounted inside each of the parts mounting grooves L. The parts mounting groove L with a part mounted thereto is carried to the suction position A of the nozzle N, a shutter 42 assembled at a cover 41 is opened so that the nozzle N can suck the part. In this state, the nozzle N sucks the part and carries it to the printed circuit board.

To carry the tape TF at a predetermined interval, a plurality of transfer holes H are formed at one end of the tape TF at a predetermined interval. To insert the tape TF into the transfer holes H formed at a predetermined interval and carry the same at a constant pitch interval, the feeding unit 30 is installed at the bottom of the tape TF. In the feeding unit 30, a rotating force is generated from the feed rotation motor 31 in order to carry the tap TF at a constant pitch interval. The rotating force generated from the feed rotation motor 31 is transferred to the feed worm 32 assembled at the central axis of rotation of the feed rotation motor 31, and thusly the sector gear 33 assembled at the bottom of the feed worm 32 is driven. When the sector gear 33 is driven, the first arm 34 and second arm 35 assembled at the sector gear 33 are driven to rotate the driving wheel 36 assembled at the second arm 35 at a constant pitch. On the outer circumferential surface of the driving wheel 36 rotated at a constant pitch, the driving teeth 36a inserted into the transfer holes H formed at the tape TF are formed at a constant interval. By the rotation of the driving wheel 36, the driving teeth 36a carries the tape TF at a constant pitch to move the part to the suction position A. Here, a reverse rotation preventing member 37 assembled at the driving wheel 36 prevents the reverse rotation of the driving wheel 36.

In the above-described feeder of the conventional art, since a large number of elements including a rotation motor, a worm gear and a linking gear are used for driving the vinyl recovery unit, the vinyl separation unit and the parts feeding unit respectively, the structure is made complex and the number of assembling process is increased. In addition, the driving wheel carrying the tape at a constant pitch is provided with the reverse rotation preventing member, thus disabling the adjustment of the position of the tape if a parts is deviated from a designated position.

### SUMMARY OF THE INVENTION

It is, therefore, an object of the present invention to provide a feeder for a surface mounting device in which the constitution of the feeder is simplified by forming integrally a parts feeding unit carrying the tape wrapped up parts at a constant pitch, thus enabling a forward/backward rotation and adjusting the feed position of the tape.

It is another object of the present invention to provide a feeder for a surface mounting device in which a parts feeding unit is formed integrally, thus performing an assembling process easily, and a forward/backward rotation of the tape is possible, thus adjusting the feed position of the tape.

To achieve the above object, there is provided a the feeder for a surface mounting device comprising: a main frame; a parts feeding unit including a forward/backward rotation force generating means being installed at one side of the main frame and for carrying a tape at a predetermined pitch interval by forwardly/backwardly rotating a circular permanent magnetic unit by a magnetic force generated between a plurality of armature coils and the permanent magnetic unit, a driving gear for receiving the forward/backward rotation force generated from the forward/backward rotation force generating means by means of a gear and simultaneously carrying the tape at a constant distance by the formation of driving teeth at the circumference surface thereto to be inserted to a tape transfer hole, a position sensing unit assembled to an end of the driving gear and for sensing the position of the circular permanent magnetic unit by an absolute position sensing device; a vinyl separation unit being connected to a side of a parts feeding unit by a first separation unit gear, and carrying the vinyl removed from the tape by the forward force generated from the forward/backward rotation force generating means or re-carrying the vinyl by the backward rotating force; and a vinyl recovery unit being connected to the vinyl separation unit by a belt, and recovering the vinyl by winding the same by the rotating force transferred from the vinyl separation unit through the belt or discharging the vinyl to the vinyl separation unit by the backward rotating force.

### BRIEF DESCRIPTION OF THE DRAWINGS

The above objects, features and advantages of the present invention will become more apparent from the following detailed description when taken in conjunction with the accompanying drawings, in which:

FIG. 1 is a perspective view of a feeder for a surface mounting device according to the conventional art;

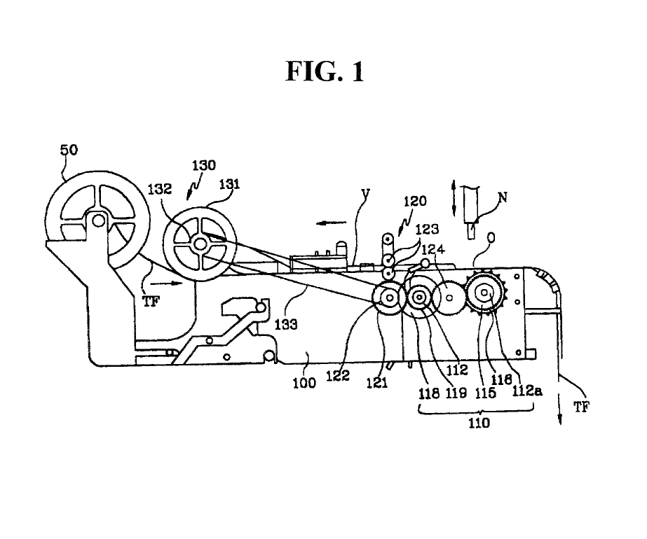

FIG. 2 is a front view of the feeder as shown in FIG. 1;

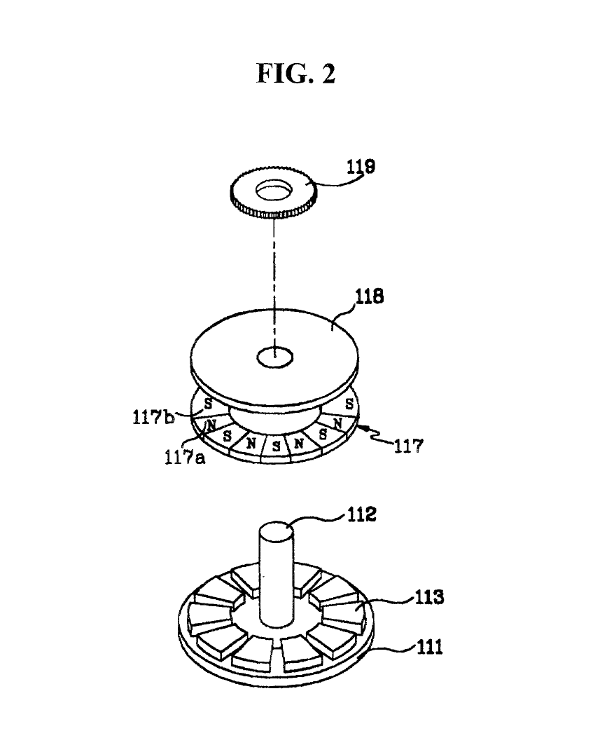

FIG. 3 is a perspective view of a shutter as shown in FIG. 1;

FIG. 4 is a front view of a feeder for a surface mounting device according to the present invention;

FIG. 5 is a perspective view of a driving unit as shown in FIG. 4;

FIG. 6 is a side cross-sectional view of the driving unit as shown in FIG. 5;

FIG. 7 is a perspective view of a driving gear and a feeding unit gear as shown in FIG. 4; and

FIG. 8 is a side cross-sectional view of the driving gear and the feeding unit gear as shown in FIG. 7.

### DETAILED DESCRIPTION OF THE PREFERRED EMBODIMENT

A preferred embodiment of the present invention will now be described with reference to the accompanying drawings.

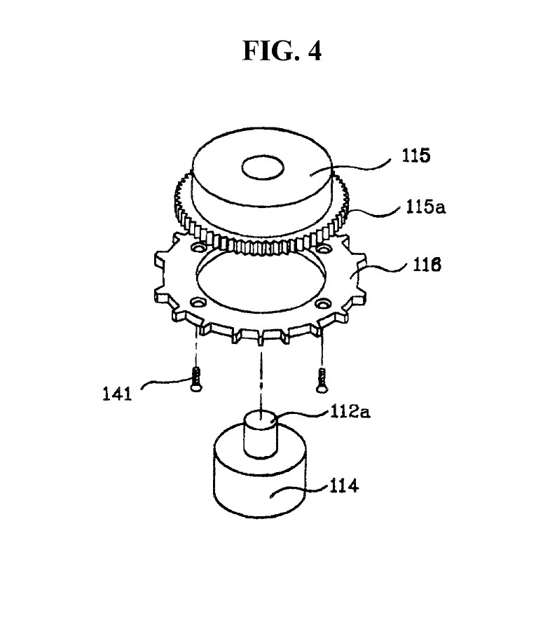

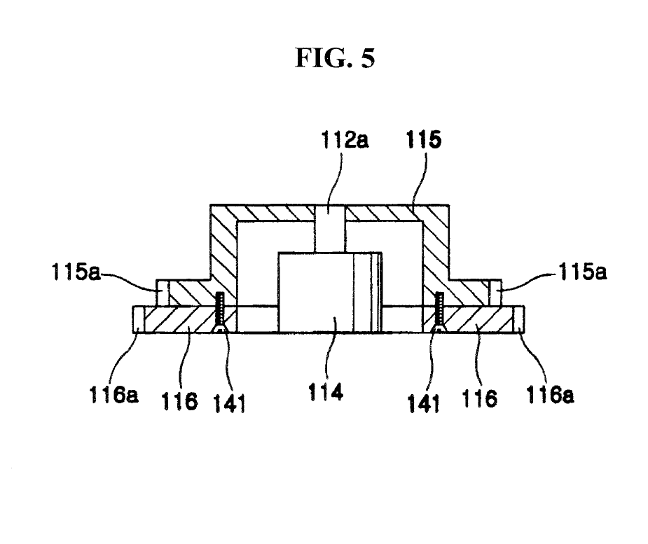

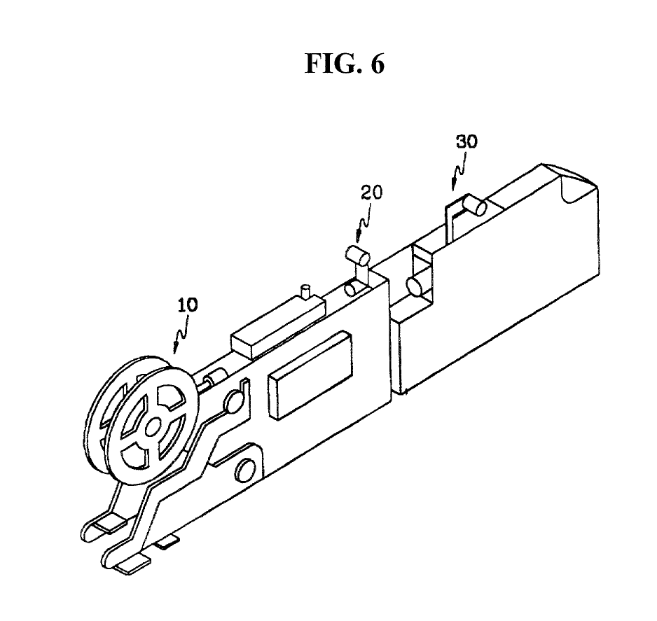

FIG. 4 is a front view of a feeder for a surface mounting device according to the present invention. FIG. 5 is a perspective view of a driving unit as shown in FIG. 4. FIG. 6 is a side cross-sectional view of the driving unit as shown in FIG. 5. The feeder for the surface mounting device according to the present invention includes: a parts feeding unit 110 being installed at one side of a main frame 100, having a plurality of armature coils 113 and a circular permanent magnetic unit 117 facing the plurality of armature coils 113, carrying a tape TF at a predetermined pitch interval by a forward/backward rotation force generated by the rotation of the circular permanent magnetic unit 117 by the interaction between the armature coils 113 and the circular permanent magnetic unit 117, and sensing a rotation speed by receiving the rotating force generated from the circular permanent magnetic unit 117 with a position sensing unit 114 for sensing the position of the circular permanent magnetic unit 117 at a predetermined distance from the circular permanent magnetic unit 117; a vinyl separation unit 120 being assembled at the main frame 100, being connected to the parts feeding unit 110, and carrying the vinyl V removed from the tape TF by the rotating force generated from the parts feeding unit 110 or re-carrying the vinyl V by the backward rotating force; and a vinyl recovery unit 130 being assembled at the other end of the main frame 130, being connected to the vinyl separation unit 120 by a belt 133, and recovering the vinyl V by winding the same by the rotating force transferred from the vinyl separation unit 120 through the belt 133 or discharging the vinyl V to the vinyl separation unit 120 by the backward rotating force.

The constitution and operation of the present invention will now be described in more detail.

The feeder for the surface mounting device of the present invention mainly includes the parts feeding unit 110, the vinyl separation unit 120, and the vinyl recovery unit 130. The parts feeding unit 110 is installed at one side of the main frame 100, and the vinyl recovery unit 130 is installed at the other side of the main frame 100. The vinyl separation unit 120 is assembled between the parts feeding unit 110 assembled at one side of the main frame 100 and the vinyl separation unit 130 assembled at the other side thereof.

The vinyl recovery unit 130 recovers the vinyl V by winding the same.

The tape TF is fed to the feeding unit 110 from a tape take-up unit 50 installed at the rear end of the vinyl recovery unit 130 along the upper side of the main frame 100. When the vinyl V is separated from the tape TF fed to the parts feeding unit 110 and a part is carried to an suction position O, a nozzle N is moved in a vertical direction to suck the part and carry it to a printed circuit board (not shown). After the suction of the part, the tape TF is discharged to the outside through the bottom of one end of the main frame 100. So that the nozzle N can suck the part, the vinyl V separated from the tape TF is hung onto the vinyl separation unit 120, is carried at a constant pitch interval of the tape TF. Here, when carrying the tape TF, if the parts is not accurately carried, the tape TF is backwardly carried, so that the nozzle N can suck the part.

To backwardly carry the tape TF by making the forward/backward rotation of the parts feeding unit 110 possible, the parts feeding unit 110 has a plurality of armature coils 113 in a circle and a circular permanent magnetic unit 117 facing the plurality of armature coils 113, for thereby generating a forward/backward rotating force by the interaction between the armature coils 113 and the circular permanent magnetic unit 117. The circular permanent magnetic unit 117 is formed of a plurality of N polar permanent magnets 117a and S polar magnets 117b arranged in turns.

A driving gear 116 has driving teeth 116a being inserted into a plurality of transfer holes H of the tape TF and carries the tape TF to the suction position O or backwardly carries the tape TF carried to the suction position O by receiving the forward/backward rotating force generated from the armature coils 113 and the circular permanent magnetic unit 117 through a gear 124. To carry the tape TF to the suction position or backwardly carry it and to sense a rotation speed generated from the circular permanent magnetic unit 117, the driving gear 116 has a position sensing unit 114 installed at the position at which the circular permanent magnetic unit 117 is installed. The rotation speed sensed by the position sensing unit 114 is used for precisely controlling the tape TF with which a part(not shown) is packaged to be carried to the suction position O of the nozzle N by a controller (not shown).

The parts feeding unit 110 and the vinyl separation unit 120 are connected so that they are synchronized and rotated by the rotation of the parts feeding unit 110 upon receipt of the forward/backward rotating force generated from the parts feeding unit 110 carrying the tape TF to the suction position O of the nozzle N. The vinyl separation unit 120 is rotated to carry the vinyl V taken off from the tape TF by the rotating force generated from the parts feeding unit 110 or to re-carry the vinyl V to the parts feeding unit 110 by the backward rotating force. That is, when the parts feeding unit 110 carries the tape to the suction position O of the nozzle N by rotation, the vinyl separation unit 120 is rotated to discharge the vinyl separated from the tape TF to the outside.

In a case that the parts feeding unit 110 backwardly carries the tape TF by backward rotation, the vinyl separation unit 120 is synchronized with the backward rotation of the parts feeding unit 110 and backwardly rotated to re-carry the vinyl V to the parts feeding unit 110. The vinyl recovery unit 130 synchronized by the forward/backward rotation of the parts feeding unit 110 and the vinyl separation unit 120 is connected to the vinyl separation unit 120 by the belt 133 to discharge the vinyl V to the vinyl separation unit 120 by the backward rotating force transferred from the vinyl separation unit 120 or to recover the vinyl V by winding the same by the rotating force.

The constitution of the parts feeding unit 110, the vinyl separation unit 120 and the vinyl separation unit 130 capable of forward/backward rotation will now be described in more detail. Firstly, the parts feeding unit 110 includes a first disc member 111, a position sensing unit 114, a feeding unit gear 115, a driving gear 116, a circular permanent magnetic unit 117, a second disc member, and a feeding unit gear 119.

The first disc member 111 is fixedly assembled at one side of the main frame 100 and has a plurality of armature coils 113 assembled on the plane at a predetermined interval and a rotating shaft 112 rotatably installed at the center. Here, the first disc member 111 is provided with a ball bearing 111a so that the rotating shaft 112 can be smoothly rotated. At one end of the rotating shaft 112 assembled at the central axis of the first disc member 111, the second disc member 118 is fixedly installed.

The second disc member 118 fixedly assembled at one end of the rotating shaft 112 is interlockingly rotated by the rotation of the rotating shaft 112. At the bottom of the second disc member 118, the circular permanent magnetic unit 117 is connected by a screw 141. The circular permanent magnetic unit 117 assembled at the second disc member 118 generated a forward/backward rotating force by the interaction with the armature coils 113 assembled at the surface of the first disc member 111. By the forward/backward rotating force generated between the permanent magnetic unit 117 and the armature coils 113, the rotating shaft 112 is forwardly/backwardly rotated.

At one end of the rotating shaft 112 forwardly/backwardly rotated, the feeding unit gear 119 is installed. The feeding unit gear 119 is inserted into the rotating shaft 112 and is assembled over the second disc member 118 at a predetermined interval to be interlockingly rotated by the rotation of the rotating shaft 112. The feeding unit gear 119 is engaged with a gear 124 as shown in FIG. 4. The feeding unit gear 119 engaged with the gear 124 rotates the driving gear 116 by the forward/backward rotating force transferred from the gear 124.

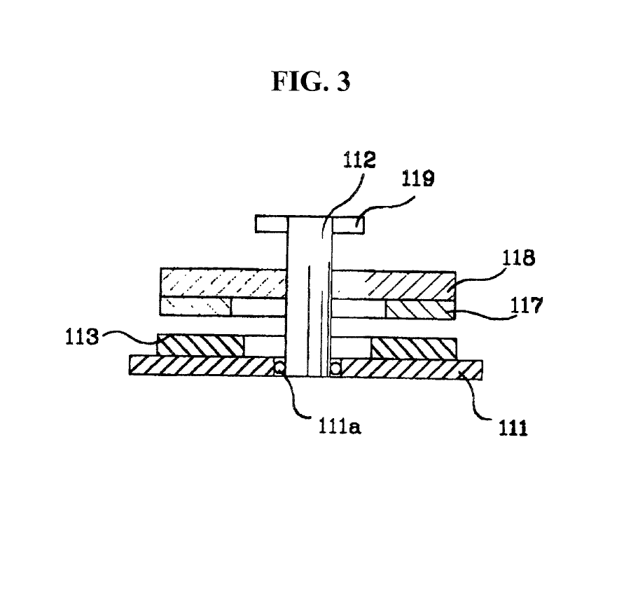

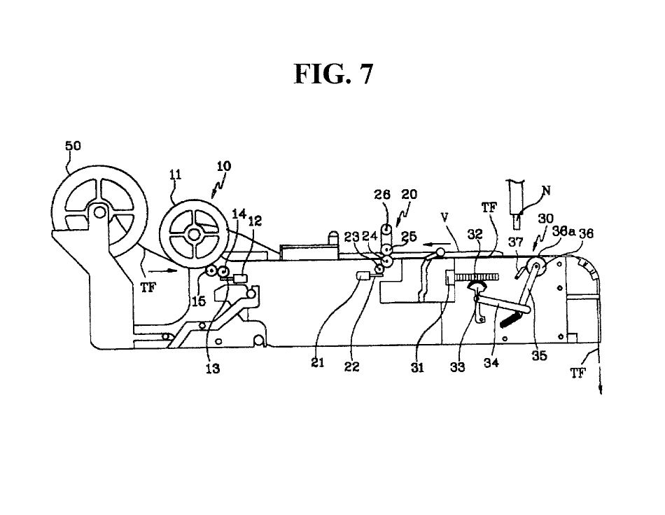

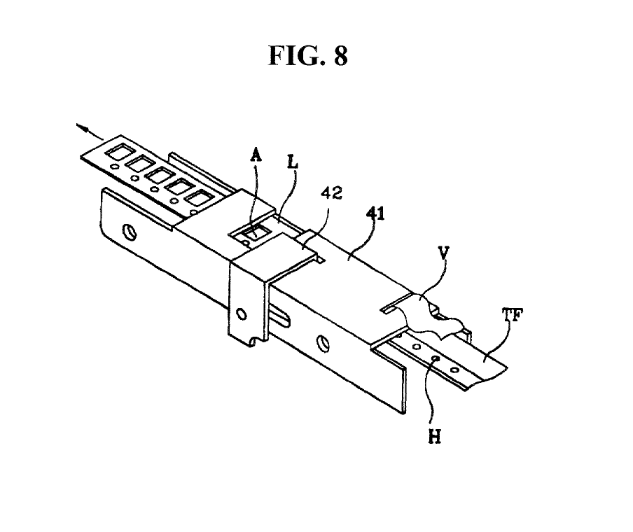

By the rotation of the driving gear 116, the tape TF is carried to the suction position O or is backwardly carried. To carry the tape TF at a constant pitch interval, driving teeth 116 are formed on the outer circumferential surface of the driving gear 116 at a constant interval as shown in FIGS. 7 and 8. The driving teeth 116a are inserted into the transfer holes (H: shown in FIG. 3) formed at the tape TF and are rotated at a constant pitch interval by the rotation of the driving gear 116 for thereby carrying the tape TF to the suction position O or backwardly carrying it.

The feeding unit gear 119 is installed at the rotating shaft 112 at which the armature coils 113 and circular permanent magnetic unit 117 generating the forward/backward rotating force for carrying the tape TF to the suction position O of the nozzle N are assembled. As shown in FIGS. 5 and 6, the feeding unit gear 119 is installed at the rotating shaft 112 by including the second disc member 118 and the circular permanent magnetic unit 117.

The feeding unit gear 115, auxiliary gear 115a and driving gear 116 are inserted into a shaft 112a of the position sensing unit 114 as shown in FIG. 7.

A rotation speed signal generated from the position sensing unit 114 is transferred to the controller (not shown) to adjust the feed operation of the tape TF more precisely. Here, the position sensing unit 114 can be assembled at one end of the driving gear 116. As the position sensing unit assembled at one end of the driving gear 116, an absolute position sensing device is used.

At the feeding unit 110 carrying the tape TF to the suction position O or sensing a rotation speed, the vinyl separation unit 120 is directly connected. That is, the feeding unit gear 119 of the parts feeding unit gear 110 and a first separation unit gear 121 are connected and thus the forward/backward rotating force transferred from the feeding unit gear 119 is transferred to the first separation unit gear 121.

The vinyl separation unit 120 receiving the forward/backward rotating force through the first separation unit gear 121 includes a first separation unit gear, a second separation unit gear 122, and a vinyl discharge gear 123. The first separation unit 121 transfers the forward/backward rotating force transferred from the feeding unit gear 119 to the second separation unit gear 122. The second separation unit gear 122 having received the forward/backward rotating force is connected to one end of the first separation unit gear 121 to thus transfer the forward/backward rotating force transferred from the first separation unit gear 121 to the vinyl discharge gear 123.

The vinyl discharge gear 123 includes a plurality of gears and is rotated in the backward direction to carry the vinyl V to the vinyl recovery unit 130 when it receives the rotating force transferred from the second separation unit gar 122 or to re-carry the vinyl V to the parts feeding unit 110 when it receives the backward rotating force. The vinyl recovery unit 130 is connected to the first separation unit gear 121 of the vinyl separation unit 120 carrying and re-carrying the vinyl V by the belt 133.

The vinyl recovery unit 130 includes a recovery unit gear 131 and a recovery reel 132. The recovery unit gear 131 is connected to the first separation unit gear 121 by the belt 133 to receive the forward/backward rotating force of the first separation unit gear 121. The recovery unit gear 131 having received the forward/backward rotating force is synchronized with the recovery reel 132 by forwardly/backwardly rotating the recovery reel 132 assembled at one side according to the forward/backward rotating force when the parts feeding unit gear 110 adjusts the feed position of the tape TF, for thereby recovering the vinyl V by winding it around the recovery reel 312 or discharging the recovered vinyl V to the vinyl separation unit 120.

As seen from above, the feeder for carrying the tape at a constant pitch is formed integrally, thus improving a feed rate and simplifying the constitution of the feeder. In addition, the feeder, vinyl separation unit and vinyl recovery unit are rotated by synchronization with one another, thus enabling a forward/backward rotation and adjusting the feed position of the tape.

As explained above, the feeder for the surface mounting device of the present invention can improve a feed rate and simplify the constitution of the feeder by forming the feeder for carrying the tape at a constant pitch integrally. In addition, the feeder, vinyl separation unit and vinyl recovery unit are rotated by synchronization with one another, thus enabling a forward/backward rotation and adjusting the feed position of the tape.

What is claimed is:

1. In a surface mounting device having a module head assembled to an X-Y gantry to be moved in an X-Y axis direction and a feeder for supplying parts to a printed circuit board carried by a transfer device in order to mount the surface mounting parts, the feeder for a surface mounting device comprising:
a main frame;
a parts feeding unit including a forward/backward rotation force generating means being installed at one side of the main frame and for carrying a tape at a predetermined pitch interval by forwardly/backwardly rotating a circular permanent magnetic unit by a magnetic force generated between a plurality of armature coils and the permanent magnetic unit, a driving gear for receiving the forward/backward rotation force generated from the forward/backward rotation force generating means by means of a gear and simultaneously carrying the tape at a constant distance by the formation of driving teeth at the circumference surface thereto to be inserted to a tape transfer hole, a position sensing unit assembled to an end of the driving gear and for sensing the position of the circular permanent magnetic unit by an absolute position sensing device;
a vinyl separation unit being connected to a side of a parts feeding unit by a first separation unit gear, and carrying the vinyl removed from the tape by the forward force generated from the forward/backward rotation force generating means or re-carrying the vinyl by the backward rotating force; and
a vinyl recovery unit being connected to the vinyl separation unit by a belt, and recovering the vinyl by winding the same by the rotating force transferred from the vinyl separation unit through the belt or discharging the vinyl to the vinyl separation unit by the backward rotating force.

2. The feeder for a surface mounting device of claim 1, wherein the forward/backward rotation force generating means comprises:
a first disc member fixedly assembled at one side of the main frame and having a plurality of armature coils assembled on its plane at a predetermined interval, a rotating shaft rotatably installed at its center by interposing a ball bearing;
a second disc member fixedly assembled at one side of the rotating shaft and linked by the rotation of the rotating shaft;
a circular permanent magnetic unit mounted between the first and second disc members and for generating a forward/backward rotation force between a plurality of armature coils; and
a feeding unit gear mounted at one side of the rotating shaft and for transferring the rotation force of the rotating shaft.

3. The feeder for a surface mounting device of claim 1, wherein the vinyl separation unit comprises:
a first separation unit connected to a feeding unit gear of the parts feeding unit;
a second separation unit connected to one end of a gear of the first separation unit and rotated by the forward/backward rotation of the gear of the first separation unit;
a vinyl discharge gear connected to a plurality of gears and rotated in the backward direction by the forward rotation of the gear of the second separation unit to carry the vinyl to the outside or to re-carry the vinyl by the backward rotation of the gear of the second separation gear.

4. The feeder for a surface mounting device of claim 1, wherein the vinyl recovery unit comprises:
a recovery unit gear connected to the vinyl separation unit by a belt and for forwardly/backwardly rotating by receiving the forward/backward rotating force generated by the vinyl separation unit; and
a recovery reel assembled at one side of the recovery unit gear, rotated according to the rotation of the recovery unit gear, thereby discharging the wound and recovered vinyl to the vinyl separation unit.
